(19) United States
(12) Patent Application Publication
(10) Pub. No.: US 2013/0325488 A1
(43) Pub. Date: Dec. 5, 2013

(54) METHODS AND SYSTEMS FOR PROVIDING COST INFORMATION FOR HEALTH CARE SERVICES

(71) Applicants: Jeffrey D. Carter, Spotsylvania, VA (US); Andrew J. Hall, Wilmington, NC (US)

(72) Inventors: Jeffrey D. Carter, Spotsylvania, VA (US); Andrew J. Hall, Wilmington, NC (US)

(21) Appl. No.: 13/486,844

(22) Filed: Jun. 1, 2012

(51) Int. Cl. G06Q 50/22; G06Q 40/08

(52) U.S. Cl. 705/2

(57) ABSTRACT

Methods and systems for providing cost information for health care services enable, among other things, health care users to make more informed and cost-effective decisions regarding their use of health care services, and/or health care providers to compete against one another on the basis of cost. According to an exemplary embodiment, a method includes: receiving, via a device, a user input requesting cost information for a health care service for a user; and providing, via the device and in response to the user input, a display including one or more health care providers and cost information for each of the one or more health care providers for providing the health care service for the user.

### BACKGROUND OF THE INVENTION

1. Field of the Invention

The present invention generally relates to health care management, and more particularly, to methods and systems which advantageously provide health care users with cost information for health care services, and thereby to enable, among other things, such health care users to make more informed and cost-effective decisions regarding their use of health care services, and/or health care providers to compete against one another on the basis of cost.

2. Background Information

Health care cost is a very important topic in today's society. One of the significant deficiencies with our current health care system is the difficulty of health care users to determine what their financial responsibility will be for receiving a particular health care service beforehand. Moreover, the ability of health care users to price shop among health care providers for a particular health care service, and the ability of health care providers to compete for business on the basis of cost is severely lacking with our current health care system. This problem may apply to health care users regardless of whether they currently have a health insurance policy in force.

Accordingly, there is a need in the art to address the foregoing issues and thereby provide health care users with the ability to make more informed and cost-effective decisions regarding their use of health care services, and/or enable health care providers to compete against one another on the basis of cost. The present invention described herein addresses these and/or other issues.

### BRIEF SUMMARY OF THE INVENTION

In accordance with an aspect of the present invention, a method is disclosed. According to an exemplary embodiment, the method comprises: receiving, via a device, a user input requesting cost information for a health care service for a user; and providing, via the device and in response to the user input, a display including one or more health care providers and cost information for each of the one or more health care providers for providing the health care service for the user.

In accordance with another aspect of the present invention, a device is disclosed. According to an exemplary embodiment, the device comprises: means for receiving a user input requesting cost information for a health care service for a user; and means for providing, in response to the user input, a display including one or more health care providers and cost information for each of the one or more health care providers for providing the health care service for the user.

In accordance with still another aspect of the present invention, another method is disclosed. According to an exemplary embodiment, the method comprises: receiving, via a device, a first user input to register a health insurance policy of a user with a first application; updating, via the first application, a data record associated with the health insurance policy in response to the user receiving a first health care service; and providing, via the device and the first application, a display including information representing a current state of the health insurance policy in response to a request by the user.

The aforementioned brief summary of exemplary embodiments of the present invention is merely illustrative of the inventive concepts presented herein, and is not intended to limit the scope of the present invention in any manner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a diagram of a system according to an exemplary embodiment of the present invention;

FIG. 2 shows a block diagram of one of the user devices of FIG. 1 according to an exemplary embodiment of the present invention;

FIG. 3 shows a process flow diagram according to an exemplary embodiment of the present invention;

FIG. 4 shows further details of one of the steps of FIG. 3 according to an exemplary embodiment of the present invention;

FIG. 5 shows further details of another one of the steps of FIG. 3 according to an exemplary embodiment of the present invention;

FIG. 6 shows an exemplary user interface that may be used for one aspect of the present invention;

FIG. 7 shows an exemplary user interface that may be used for another aspect of the present invention;

FIG. 8 shows an exemplary user interface that may be used for yet another aspect of the present invention; and

FIG. 9 shows an exemplary user interface that may be used for still yet another aspect of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

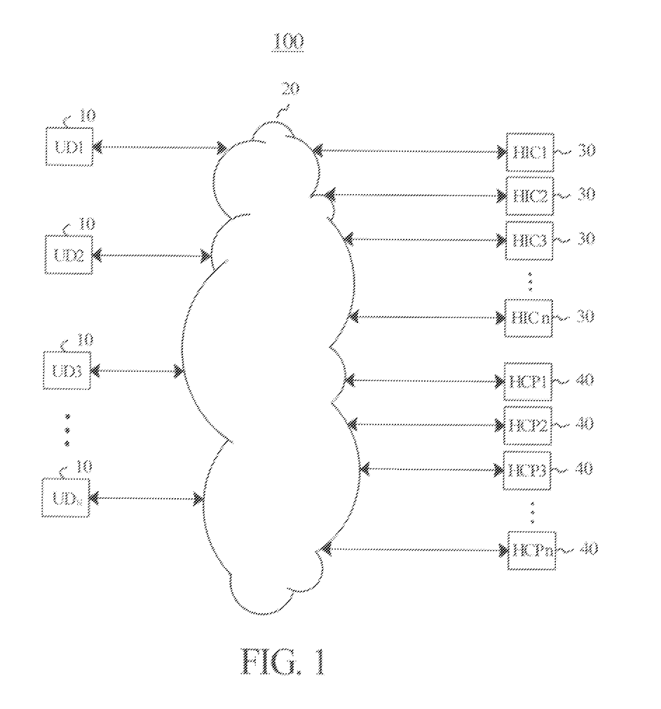

Referring now to the drawings, and more particularly to FIG. 1, a diagram of a system 100 according to an exemplary embodiment of the present invention is shown. As indicated in FIG. 1, system 100 comprises a plurality of user devices (UD1-UN_{N}) 10, a network/storage/computing cloud 20, a plurality of health insurance companies (HIC1-HICₙ) 30, and a plurality of health care providers (HCP1-HCPₙ) 40.

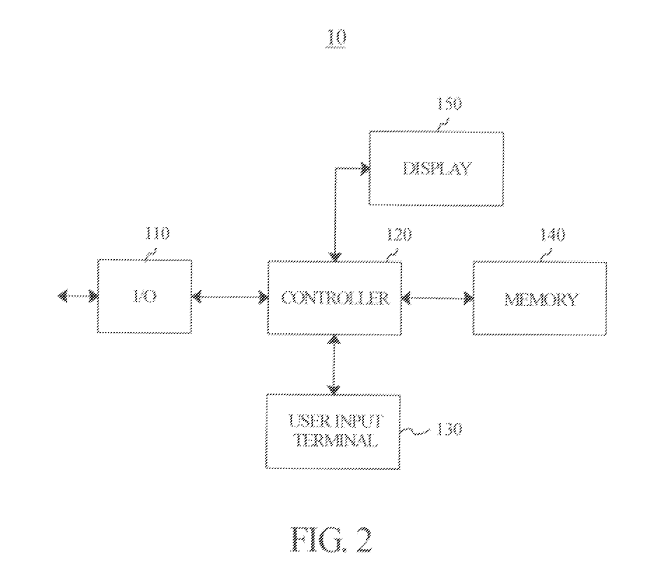

According to an exemplary embodiment, each user device (UD1-UN_{N}) 10 of FIG. 1 is operative to electronically communicate in a wired and/or wireless manner with one or more other devices and/or systems via network/storage/computing cloud 20. According to an exemplary embodiment, each user device (UD1-UN_{N}) 10 may be embodied as any type of electronic system, such as a mobile hand-held device (e.g., smart phone, smart pad, etc.), personal computer (e.g., desktop or laptop computer, etc.) and/or other type of electronic device. Further exemplary details regarding user devices (UD1-UN_{N}) 10 will be provided later herein with reference to FIG. 2.

According to an exemplary embodiment, network/storage/computing cloud 20 of FIG. 1 is operative to provide data communication, data storage, computing/processing and/or other functions of system 100, as may be described herein. For example, cloud 20 may include portions of an intranet and/or the global communication network known as the Internet, as well as associated data storage and processing facilities. The data storage and computing/processing facilities associated with cloud 20 may, for example, be owned, operated and/or controlled by one or more entities that administer a health care cost application referred to herein as the Cost MD™ application, which enables users to request and receive cost information for various health care services.

Cloud 20 may be operative to download the Cost MD™ application to one or more user devices 10, where such application may be executed internally by the particular user device 10. Alternatively or additionally, cloud 20 may be operative to execute computer software which provides and maintains a website (e.g., www.costmd.com etc.) that enables users to utilize the Cost MD™ application, as described herein (without necessarily downloading the application to user device 10).

According to an exemplary embodiment, each of the health insurance companies (HIC1-HICn) 30 of FIG. 1 may include equipment infrastructure (e.g., server(s), etc.) that is operatively coupled to network/storage/computing cloud 20. According to an exemplary embodiment, one or more of the health insurance companies (HIC1-HICn) 30 provides an insurance application which enables certain subscribers to, among other things, register a health insurance policy with the health insurance application, track usage of health care services, access information regarding a current state of the health insurance policy, and access the Cost MD™ application.

According to an exemplary embodiment, the health insurance application maintains and provides subscriber information related to the health insurance policy (e.g., how much of the subscriber's deductible has been met, co-payment information for different services, health savings account balance, to etc.), and updates data records for individual subscribers in response to the subscribers receiving health care service(s) from health care provider(s), such as one or more of the health care providers (HCP1-HCPn) 40.

Also according to an exemplary embodiment, the health insurance application enables a subscriber to selectively link information associated with his/her health insurance policy to, and access, the aforementioned Cost MD™ application, which enables the subscriber to request and receive cost information for various health care services. Further exemplary details regarding the aforementioned health insurance application and Cost MD™ application according to principles of the present invention will be provided later herein.

According to an exemplary embodiment, each of the health care providers (HCP1-HCPn) 40 may provide at least a portion of a health care service whose cost is requested by a user according to principles of the present invention. As referred to herein, the term “health care service” may refer to any type of service related to a user's health, and a given “health care service” may include services from a plurality of different individual health care providers. For example, a “health care service” corresponding to the procedure of a “colonoscopy” may include services from a hospital or surgery center, as well as services from one or more physicians including a gastroenterologist and anesthesiologist, and/or other services. Each of these different individual health care providers (HCP1-HCPn) 40 may charge a separate fee for performing a respective part of the particular health care service. Also, one or more of these different individual health care providers (HCP1-HCPn) 40 may be part of an entity known as an Accountable Care Organization (ACO), or an equivalent or similar type of entity.

Referring to FIG. 2, a block diagram of one of the user devices 10 of FIG. 1 according to an exemplary embodiment of the present invention is shown. As indicated in FIG. 2, user device 10 comprises input/output (I/O) means such as I/O block 110, control and processing means such as controller block 120, user input means such as user input terminal 130, data to storage means such as memory 140, and display means such as display 150. Some of the foregoing elements of FIG. 2 may be embodied using one or more integrated circuits (ICs). For clarity of description, certain conventional elements associated with user device 10 such as certain control signals, power signals and/or other elements may not be shown in FIG. 2.

I/O block 110 is operative to perform I/O functions of user device 10. According to an exemplary embodiment, I/O block 110 is operative to receive and output signals in a wired and/or wireless manner from and to, respectively, one or more signal sources. I/O block 110 may be embodied as any type of I/O interface capable of receiving wired and/or wireless signals, and may be comprised of one or more individual components (e.g., antenna, plug(s), etc.).

Controller 120 is operative to perform various signal processing and control functions of user device 10. According to an exemplary embodiment, controller 120 receives the signals provided from I/O block 110 and performs and/or enables all necessary processing and control functions associated with user device 10. For example, controller 120 is operative to perform and/or enable various functions including, but not limited to, processing user inputs made via user input terminal 130, reading and writing data from and to memory 140, enabling on-screen displays (e.g., menus, browsers, etc.) via display 150, and/or other operations.

Controller 120 may also have an integrated global position satellite (GPS) unit that enables controller 120 to determine the current geographical location of user device 10 at any given time. Controller 120 is also operative to execute software code (e.g., applications) that facilitates and enables performance of the various embodiments and methods of the present invention described herein. Further details regarding these aspects of the present invention will be provided later herein.

User input terminal 130 is operative to receive all types of user inputs from an operator of user device 10. According to an exemplary embodiment, user input terminal includes one or more keys and/or other input elements (e.g., mouse, touch pad, voice input, etc.). Inputs provided via user input terminal 130 are provided to controller 120 which processes such inputs.

Memory 140 is operatively coupled to controller 120 and performs data storage functions of user device 10. According to an exemplary embodiment, memory 140 stores data including, but not limited to, software code and other data associated with one or more computer applications including those described herein, on-screen display data (e.g., menus, browsers, etc.), user selection/setup data, and/or other data.

Display 150 is operative to provide visual displays to an operator of user device 10 pursuant to the control of controller 120. According to an exemplary embodiment, display 150 may be embodied as any type of suitable display device, such as a light emitting diode (LED) display, liquid crystal display (LCD), cathode ray tube (CRT) display, plasma display, digital light processing (DLP) display or other type of display device. Display 150 may also have touch-screen capabilities and thereby enable an operator to provide inputs to controller 120.

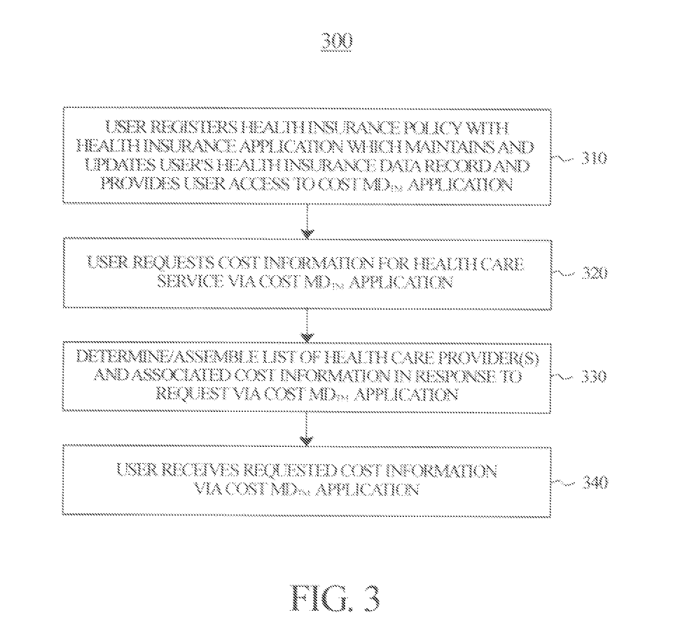

Referring to FIG. 3, a process flow diagram 300 according to an exemplary embodiment of the present invention is shown. For purposes of example and explanation only, the steps of FIG. 3 may be described with specific reference to the exemplary embodiments of FIGS. 1 and 2 previously described herein. The steps of FIG. 3 are exemplary only, and are not intended to limit the applicability of the present invention in any manner.

At step 310, a user registers a health insurance policy with the aforementioned health insurance application which maintains and updates the user's health insurance data record based on, among other things, the user's use of health care services. The health insurance application also advantageously provides the user with one-click access to the aforementioned Cost MD™ application, which enables the user to request and receive cost information for various health care services. According to exemplary embodiments, step 310 is optional in that certain principles of the present invention, such as use of the Cost MD™ application, may be implemented and practiced without users having a health insurance policy in force.

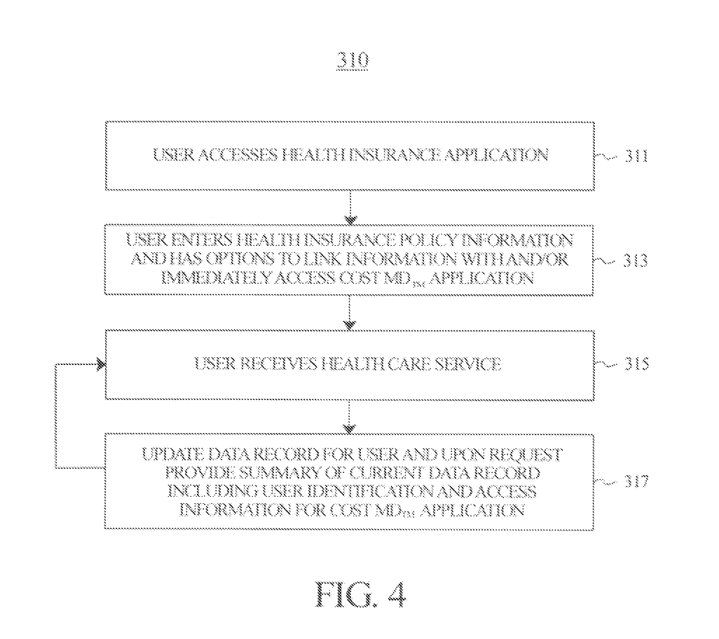

Referring now to FIG. 4, further details of step 310 of FIG. 3 according to an exemplary embodiment of the present invention are shown.

At step 311 of FIG. 4, the user accesses the health insurance application via user device 10. According to an exemplary embodiment, the health insurance application has been previously downloaded to user device 10 from, for example, a website associated with a given health insurance company, and the user accesses the health insurance application at step 311 via a menu system (not shown) associated with user device 10. However, if the health insurance application has not been previously downloaded to user device 10, such downloading may occur at step 311. Pursuant to such downloading, executable software code associated with the health insurance application is stored in memory 140 and may be executed by controller 120 in response to, for example, a user input entered via terminal 130.

According to an alternative embodiment, the user may access the health insurance application at step 311 by simply accessing the website associated with the health insurance application, and without actually downloading the application to user device 10. In such a case, the health insurance application may be executed and maintained by a computing system (e.g., server, etc.) associated with the given health insurance company.

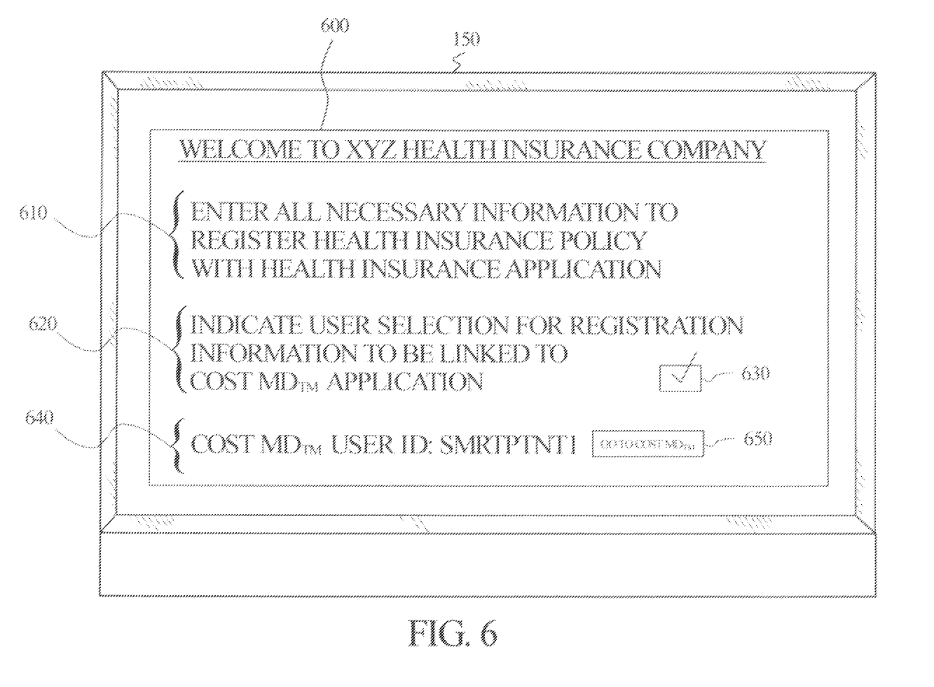

At step 313, the user enters all necessary health insurance policy information to register the health insurance policy (e.g., individual policy, family policy, business/company policy, etc.) with the health insurance application according to an exemplary embodiment of the present invention. FIG. 6 shows an exemplary user interface 600 that may be used at step 313 of FIG. 4 according to an exemplary embodiment of the present invention. User interface 600 of FIG. 6 is exemplary only and is not intended to limit the present invention in any manner.

As indicated by element 610 of FIG. 6, the user enters all necessary health insurance policy information to register the health insurance policy (e.g., individual policy, family policy, business/company policy, etc.) with the health insurance application. For example, the user may enter information such as name(s), address(es), date(s) of birth, policy identification number, group number and/or other information. Although not expressly shown in FIG. 6, after registering the health insurance policy with the health insurance application, the user may receive a password (e.g., via e-mail or otherwise) that enables the user to access the health insurance application in the future (e.g., to check status of deductible and/or other policy information, modify the election regarding box 630, etc.).

Also at step 313, the user elects whether or not to link the particular health insurance policy with the aforementioned Cost MD™ application, which advantageously enables the user to request and receive cost information for various health care services according to principles of the present invention. As indicated by element 620 of FIG. 6, the user may affirmatively make the election at step 313 by, for example, selectively checking a predetermined box 630 of user interface 600.

If the user elects to link the particular health insurance policy with the Cost MD™ application at step 313, the particular health insurance policy is linked with the Cost M™ application in a manner such that the Cost MD™ application is authorized to access and retrieve data and information associated with the particular health insurance policy for purposes of determining cost information requested by the user.

Once the particular health insurance policy is linked with the Cost MD™ application, the health insurance application may provide the user with an to initial default user identification code (e.g., “SMRTPTNT1”) represented as element 640 in FIG. 6 that may be used in the future as a password for conveniently linking information associated with the particular health insurance policy to the Cost MD™ application when using the latter application to request health care cost information. Of course, this initial default user identification code/password, which is coordinated with and recognized by the Cost MD™ application, may be modified by the user, as desired.

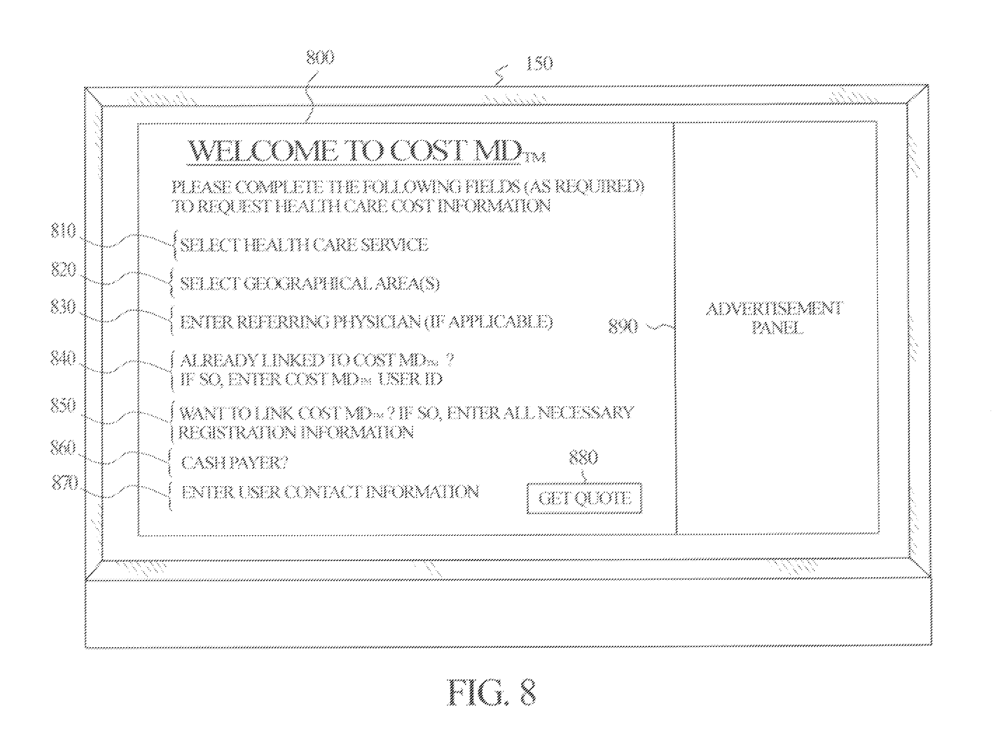

Also indicated in FIG. 6, the user may immediately and automatically access the Cost MD™ application at step 313 by, for example, selecting (e.g., clicking on) a predetermined icon 650 of user interface 600. According to an exemplary embodiment, such a user selection causes user device 10 to immediately close the health insurance application of FIG. 6, and automatically initiate access to (e.g., download and/or execute) the Cost MD™ application (see, for example, FIG. 8 to be described later herein).

If the Cost MD™ application has not been previously downloaded to user device 10 when the user selects icon 650 of user interface 600, such downloading from, for example, a website associated with the Cost MD™ application may occur in response to such selection. Pursuant to such downloading, executable software code associated with the Cost MD™ application is stored in memory 140 of user device 10, and may be executed by controller 120 in response to, for example, a user input entered via terminal 130.

According to an alternative embodiment, the user may access the Cost MD™ application by simply accessing the website associated with the Cost MD™ application, and without actually downloading the application to user device 10. In such a case, the Cost MD™ application as described herein may be executed and maintained by a computing system (e.g., server(s), etc.) associated with the Cost MD™ website, such as cloud 20 of FIG. 1.

Once the Cost MD™ application is accessed via icon 650 of user interface 600, the user does not need to enter any policy identification information, as such information is automatically provided to the Cost MD™ application by the health insurance application in response to selection of icon 650 of user interface 600.

Conversely, if the user elects not to link the health insurance policy with the Cost MD™ application at step 313, the particular health insurance policy is not linked with the Cost MD™ application (until and unless otherwise properly directed by the user). According to an exemplary embodiment, even if the user elects not to link the health insurance policy with the Cost MD™ application at step 313, he/she may still utilize icon 640 of user interface 600 to immediately and automatically access (e.g., download and/or execute) the Cost MD™ application.

According to an alternative exemplary embodiment, however, the user may not be able to utilize icon 640 of user interface 600 to immediately and automatically access the Cost MD™ application unless he/she has affirmatively elected to link the particular health insurance policy with the Cost MD™ application at step 313 (e.g., by checking box 630 of user interface 600).

From step 313, process flow advances to step 315 where the user receives a health care service from one or more individual health care providers. According to an exemplary embodiment, the health care service provided to the user at step 315 may include a plurality of different individual services provided by a plurality of different individual health care providers. For example, a procedure such as a colonoscopy may include, for example, services from a hospital or surgery center, as well as services from one or more physicians including a gastroenterologist and anesthesiologist, and/or other services. Each of these different individual health care providers may charge a separate fee for performing a respective part of the particular health care service. According to an exemplary embodiment, the specific health care providers providing the health care service at step 315 may be part of entity known as an Accountable Care Organization (ACO).

At step 317, the health insurance application updates a data record for the user in response to the health care service received at step 315. For example, if the user has an office visit with a particular physician, the current data record for the user is updated to reflect the charge for that visit. Alternatively, if the health care service (e.g., colonoscopy, etc.) provided to the user at step 315 includes a plurality of different individual services provided by a plurality of different individual health care providers, the current data record for the user is updated to reflect the individual charges for each and every health care provider, as bills for such services are received and processed by the health insurance company.

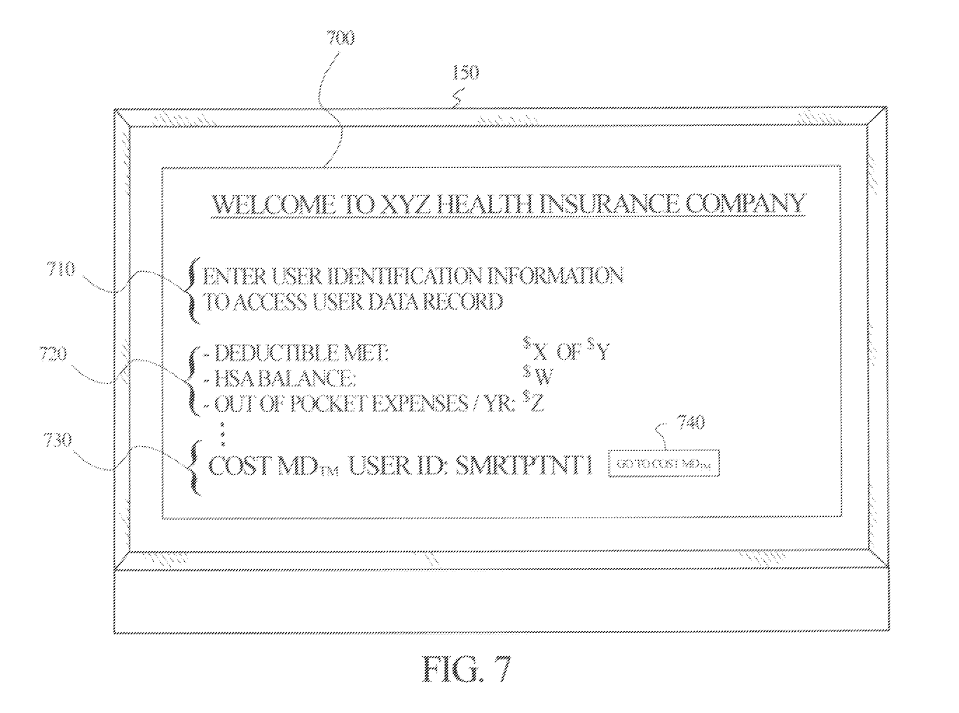

Also at step 317, upon proper user request, a summary of the current data record is provided to the user via user device 10. FIG. 7 shows an exemplary user interface 700 that may be used at step 317 of FIG. 4 according to an exemplary embodiment of the present invention. User interface 700 of FIG. 7 is exemplary only and is not intended to limit the present invention in any manner.

As indicated by element 710 of FIG. 7, the user may enter all necessary identification information sufficient to gain access to the user's current data record. According to an exemplary embodiment, the user may quickly and conveniently gain access to the user's current data record at step 317 by entering a valid password, such as the one previously provided by the health insurance application as a result of the aforementioned registration process.

Once access to the user's current data record is achieved at step 317, a plurality of different types of information related to the applicable health insurance policy are displayed to the user. Element 720 of FIG. 7 shows a plurality of different types of exemplary information (i.e., amount of deductible met, health savings account (HSA) balance and contribution information, out of pocket expenses for the current year, etc.) that may be provided by the health insurance application as part of the user's current data record at step 317. Of course, other types of relevant information may also, and/or alternatively, be provided as part of element 720 of FIG. 7 according to principles of the present invention. A plurality of different individual screens may be provided to display all of the relevant information associated with element 720.

Also at step 317, and as indicated by element 730 in FIG. 7, for example, the health insurance application may provide the user with an indication (e.g., reminder) of the user identification code (“SMRTPTNT1” by example in FIGS. 6 and 7) that may be used as a password for conveniently linking information associated with the particular health insurance policy to the Cost MD™ application when using the latter application to request health care cost information. Of course, this initial default user identification code/password may be modified by the user, as desired.

Also at step 317, the health insurance application may immediately and automatically access the Cost MD™ application through a one-click process. As indicated in FIG. 7, the user may automatically access the Cost MD™ application at step 317 by, for example, selecting (e.g., clicking on) a predetermined icon 740 of user interface 700 when the Cost MD™ application has been previously downloaded and stored by user device 10.

According to an exemplary embodiment, such a user selection causes controller 120 of the applicable user device 10 to immediately close the health insurance application of FIG. 7, and automatically initiate access to the Cost MD™ application/website (see, for example, FIG. 8 to be described later herein). Moreover, once the Cost MD™ application is accessed via icon 740, the user does not need to enter any policy identification information, as such information is automatically provided to the Cost MD™ application by the health insurance application in response to selection of predetermined icon 740 of user interface 700. As indicated in FIG. 4, process flow loops from step 317 to step 315, and such steps may be repeatedly performed.

Referring back to FIG. 3, at step 320, the user requests cost information for a specified health care service via user device 10 and the Cost MD™ application. According to exemplary embodiments, step 320 may be performed even if a user has not performed step 310 (e.g., the user has no health insurance policy, or otherwise has not registered a health insurance policy at step 310). As referred to herein, the “health care service” specified at step 320 may refer to any type of service related to a user's health (including, for example, dental and/or oral care, etc.), and a given “health care service” may include services from a plurality of different individual health care providers.

According to exemplary embodiments, the user request at step 320 may be the result of a physician referral, prescription or recommendation (e.g., primary care physician recommends that user get a colonoscopy, particular blood test(s), and/or other type of medical procedure/service, etc.). Alternatively, the user request at step 320 may not include any type of physician referral, prescription or recommendation (e.g., user wants to check a particular primary care physician's prices for a regular office visit and/or other services, etc.). The request at step 320 may also be initiated by a health care provider (e.g., in a physician's office and/or other professional health care service environment, etc.) on the user's behalf.

According to exemplary embodiments, the Cost MD™ application is a separate and distinct computer application than the health insurance application previously described herein. According to other exemplary embodiments, however, the functionality of the Cost MD™ application described herein may be integrated with the functionality of the health insurance application previously described herein to form a single application, which may be offered for example by one or more health insurance companies (e.g., HIC1-HICn 30 in FIG. 1).

According to an exemplary embodiment, the Cost MD™ application has been previously downloaded to user device 10 from, for example, a website associated with the Cost MD™ application (e.g., www.costmd.com, etc.) and the user accesses the Cost MD™ application at step 320 via a menu system associated with user device 10. However, if the Cost MD™ application has not been previously downloaded to user device 10, such downloading may occur at step 320. Pursuant to such downloading, executable software code associated with the Cost MD™ application is stored in memory 140 and may be executed by controller 120 in response to, for example, a user input entered via terminal 130.

According to an alternative embodiment, the user may access the Cost MD™ application at step 320 by simply accessing the website associated with the Cost MD™ application, and without actually downloading the application to user device 10. In such a case, the Cost MD™ application may be executed and maintained by a computing system associated with the Cost MD™ website (e.g., cloud 20 of FIG. 1, etc.).

FIG. 8 shows a user interface 800 that may be used at step 320 of FIG. 3 according to an exemplary embodiment of the present invention. User interface 800 of FIG. 8 is exemplary only and is not intended to limit the present invention in any manner. As indicated in FIG. 8, a plurality of different user input areas represented as elements 810 to 870 may be provided to the user at step 320 of FIG. 3. Some of these elements 810 to 870 of FIG. 8 may be optional according to certain exemplary embodiments of the present invention.

Element 810 represents a user input area used to select a health care service for which cost information is being requested. Element 810 may be implemented in various different ways. For example, element 810 may include one or more drop-down menus that provide a listing of pre-defined health care services from which the user may select. Alternatively or additionally, element 810 may include a text entry section in which a user may enter alphabetic characters of a health care service. According to another exemplary embodiment, the selected health care service may be specified by one or more medical diagnostic codes. This type of health care service identification may be particularly useful in embodiments implemented in, for example, a physician's office and/or other professional health care service environment.

According to an exemplary embodiment, the health care service selected under element 810 may be any type of service related to a user's health, and may include a plurality of different individual services provided by a plurality of different individual health care providers. For example, a procedure such as a colonoscopy may include, for example, services from a hospital or surgery center, as well as services from one or more physicians including a gastroenterologist and anesthesiologist, and/or other services. Each of these different individual health care providers may charge a separate fee for performing a respective part of the particular health care service. According to an exemplary embodiment, the specific health care providers providing the health care service selected under element 810 may be part of entity known as an Accountable Care Organization (ACO).

Element 820 represents a user input area used to select one or more geographical areas/locations in which the health care service selected under element 810 is provided. Element 820 may be implemented in various different ways. For example, element 820 may include one or more drop-down menus of pre-defined geographical areas from which the user may select one or more such areas. Alternatively or additionally, element 820 may include a text entry section in which a user may manually enter alphabetic characters of one or more geographical areas.

Element 820 is optional in that the applicable user device 10 may include a built-in GPS unit that automatically determines the geographical area where the user device 10 is presently located and uses that determined geographical area for purposes of the user's cost information request. This type of automatic determination of the applicable geographical area may be useful in emergency situations where the user needs a health care service but is out of town, such as on a business trip or on vacation. According to an exemplary embodiment, the applicable user device 10 may include a built-in GPS unit that automatically determines the geographical area where the user device 10 is presently located (e.g., according to a default setting of user device 10), but also provide the user input area represented by element 820 so that the user can supplement and/or override the determination of the GPS unit.

Element 830 represents a user input area used to enter a referring physician or other referring health care provider/entity (if any) for the health care service selected under element 810. Such a factor may be taken into consideration by the Cost MD™ application when determining requested cost information. The information entered under element 830 is important since it enables, for example, different health care providers to establish strategic business alliances with other health care providers for purposes of providing preferred cost options (e.g., discounts) for their respective patients upon proper referral. For example, the Cost MD™ application may include a section (not expressly shown herein) where individual health care providers (e.g., HCP1-HCPn 40 in FIG. 1) can communicate and/or establish such strategic business alliances with other health care providers for purposes of providing preferred cost options (e.g., discounts) for their respective patients upon proper referral.

As an example, if a given primary care physician refers a user/patient to a given imaging center and the primary care physician and imaging center have an established strategic business alliance via the Cost MD™ application, the user/patient may receive a pre-defined (e.g., negotiated between the health care providing parties beforehand, etc.) discount in the cost quote for the selected health care service for which cost information is being requested. The information related to element 830 may be specified by health care providers during a registration process with the Cost MD™ application in which the health care providers provide, among other things, their associated cost information. This registration process will discussed further later herein. Element 830 may be optional according to certain exemplary embodiments of the present invention.

Element 840 represents a user input area used to quickly and conveniently link current information from the user's health insurance policy to the Cost MD™ application when the user has previously elected (e.g., by checking predetermined box 630 in FIG. 6), via the health insurance to application as previously described herein, to link such policy information to the Cost MD™ application. For example, the user may enter a current user identification code/password (e.g., “SMRTPTNT1” in FIGS. 6 and 7) under element 840 of FIG. 8 to thereby conveniently link information associated with the user's health insurance policy to the Cost MD™ application when using the latter application to request health care cost information.

Element 850 represents a user input area in which the user can create a link between a particular health insurance policy and the Cost MD™ application (e.g., in instances where the user has not previously done so via the health insurance application). As such, the user input area of element 850 in FIG. 8 enables the user to enter the same or equivalent information as that represented by elements 610 to 630 in FIG. 6.

Elements 840 and 850 of FIG. 8 are optional according to certain exemplary embodiments of the invention in that use of the Cost MD™ application may be implemented and practiced without users even having a health insurance policy in force. Moreover, as previously discussed herein, according to exemplary embodiments where a health insurance policy is being taken into consideration for purposes of providing cost information, users may immediately and automatically access the Cost MD™ application (without the requirement of any user input under elements 840 and 850 of FIG. 8) by using icons 650 and 740 of FIGS. 6 and 7, respectively. Although not shown in FIG. 8, the Cost MD™ application may also include a user option to expressly indicate that no health insurance will be used for the selected health care service (i.e., element 810) for which cost information is being requested.

Element 860 represents a user input area used to indicate (Y/N) if the user is a “cash payer”. As referred to herein, being a “cash payer” indicates that the user will not be using health insurance for the selected health care service, and that the user intends to pay “cash” (e.g., cash, credit, check, etc.) to the health care service provider for the full amount of the health care service at the time of service. Of course, other definitions for a “cash payer” may also be employed according to principles of the present invention. Such a factor may be taken into consideration by the Cost MD™ application when determining requested cost information. For example, a “cash payer” may receive a given discount (e.g., 10%, etc.) from certain health care providers. The information related to element 860 may be specified by health care providers during the registration process with the Cost MD™ application in which they provide, among other things, their associated cost information. Element 860 may be optional according to certain exemplary embodiments of the invention.

Element 870 represents a user input area in which the user enters his/her contact information, such as a mailing address, e-mail address, telephone number, and/or other type of contact information. Element 870 may be optional according to certain exemplary embodiments of the invention.

Element 880 represents an icon by which the user may select (e.g., click on) to formally submit his/her request for cost information via the Cost MD™ application. Although shown together in a single on-screen display in FIG. 8, elements 810 to 880 may be shown and represented to the user in a plurality of different screen displays.

Also indicated in FIG. 8, an advertisement panel 890 may be provided by the Cost MD™ application. According to exemplary embodiments, advertisement panel 890 provides a visual display of one or more individual advertisements and/or other types of information (e.g., sponsorship information, news feed information relating to the Cost MD™ application, current events, etc.). According to certain exemplary embodiments, such advertisements may be limited to ads for health care services/providers. However, according to other exemplary embodiments, the content displayed by advertisement panel 890 may also include ads related to other industries, and/or other types of information.

According to an exemplary embodiment, space within advertisement panel 890 may be offered, on a prioritized basis, to health care providers that have registered their cost information with the Cost MD™ application. In this manner, the health care providers that have registered their cost information with the Cost MD™ application may be given priority over, and/or offered preferred advertising rates over other potential advertising customers that have no affiliation with the Cost MD™ application and/or its sponsors.

According to an exemplary embodiment, advertisement panel 890 may display advertisements for health care providers registered with the Cost MD™ application in a manner that is responsive (e.g., in real-time) to the user's selection of a specific health care service under element 810. For example, if a user specifies a particular blood test(s) under element 810, advertisement panel 890 may display only (or in some prioritized manner) advertisements for health care providers (e.g., testing laboratories, etc.) registered with the Cost MD™ application for performing the particular blood test(s). As another example, if a user specifies a particular surgical procedure (e.g., gallbladder removal, appendix removal, hip replacement, etc.) under element 810, advertisement panel 890 may display only (or in some prioritized manner) advertisements for health care providers (e.g., surgical groups, etc.) registered with the Cost MD™ application for performing the particular surgical procedure. As still another example, if a user specifies a particular imaging procedure (e.g., x-ray, ultrasound, CAT scan, PET scan, fluoroscopy, etc.) under element 810, advertisement panel 890 may display only (or in some prioritized manner) advertisements for health care providers (e.g., radiology groups, etc.) registered with the Cost MD™ application for performing the particular imaging procedure. Of course, a multitude of other examples exist, and such principles of coordinated display (e.g., in real-time) between the advertisements displayed by advertisement panel 890 and the health care service specified under element 810 may be applied for all different types of health care services and providers.

Referring now back to FIG. 3, in response to the user formally submitting his/her request for cost information via the Cost MD™ application (e.g., by selecting element 880 of FIG. 8) at step 320, process flow advances to step 330.

At step 330 of FIG. 3, a list of one or more health care providers registered to perform the health care service specified in step 320, along with the associated cost information is determined and assembled in response to the user input of step 320 via the Cost MD™ application.

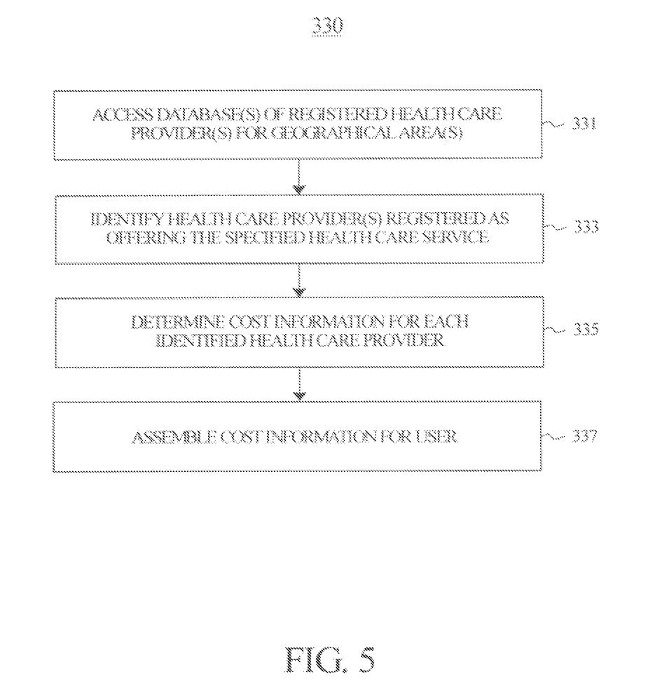

Referring to FIG. 5, further details of step 330 of FIG. 3 according to an exemplary embodiment of the present invention are shown.

At step 331 of FIG. 5, the applicable user device 10 executing the Cost MD™ application (or applicable computing system of a website associated with the Cost MD™ application, if the application has not been downloaded) accesses, in response to the user request of step 320, one or more databases including data related to one or more health care providers (e.g., HCP1-HCPn 40 in FIG. 1) in one or more geographical areas.

According to exemplary embodiments in which the Cost MD™ application has been downloaded to a user device 10, controller 120 of the applicable user device 10 executes the Cost MD™ application at step 331 to thereby search one or more databases.

According to other exemplary embodiments in which the Cost MD™ application has not been downloaded to a user device 10, a computing system associated with the Cost MD™ website (e.g., cloud 20 of FIG. 1, etc.) executes the Cost MD™ application at step 331 to thereby search one or more databases. Such database(s) may, for example, be owned, operated and/or controlled by one or more entities associated with the Cost MD™ application, such as any entity or party associated with any of the elements represented in FIG. 1.

At step 333, the user device 10 executing the Cost MD™ application (or applicable computing system of a website associated with the Cost MD™ application, if for example the application has not been downloaded) identifies one or more health care providers in the database(s) accessed at step 331 to that are registered to provide the health care service specified by the user at step 320.

According to exemplary embodiments in which the Cost MD™ application has been downloaded to a user device 10, controller 120 of the applicable user device 10 executes the Cost MD™ application at step 333 to thereby identify in the database(s), one or more health care providers that are registered to provide the health care service specified at step 320.

According to other exemplary embodiments in which the Cost MD™ application has not been downloaded to a user device 10, a computing system associated with the Cost MD™ website (e.g., cloud 20 of FIG. 1, etc.) executes the Cost MD™ application at step 333 to thereby identify in the database(s), one or more health care providers that are registered to provide the health care service specified at step 320.

According to exemplary embodiments, the database(s) accessed at step 331 include cost information provided from health care providers (e.g., HCP1-HCPn 40 in FIG. 1) through a registration process with the Cost MD™ application in which the health care providers provide various information in order to formally offer their services, and have their associated cost information listed, through the Cost MD™ application.

According to exemplary embodiments, such registration information comprises: all necessary identification information for the health care provider, the health care services they offer, the health insurance companies (carriers) whose insurance they accept for such services, and all of their corresponding cost information. For example, with respect to cost information that involves health insurance, a health care provider may provide a plurality of different costs for each health care service they offer, where each cost may represent a negotiated rate between the particular health insurance company and health care provider for that particular health care service. Such registered cost information also preferably includes, for each health care service the health care provider offers, a cost when health insurance is not being used, and/or a cost when the user is a “cash payer” as described herein.

For certain health care services, the cost information provided during the registration process may be represented as a range which depends, for example, on the particular health care service and/or the circumstances of the underlying health issue. That is, the cost information registered with the Cost MD™ application by the respective health care providers (and ultimately presented to users) may represent only cost estimates for having particular health care services performed. Such estimates may be binding or non-binding depending on, for example, the nature of the particular health care service and/or the policies of the particular health care provider. According to an exemplary embodiment, cost information that represents only an estimate may be displayed to users with a predetermined notation, such as an asterisk (*) or the like.

According to exemplary embodiments, the registration process with the Cost MD™ application for health care providers may be similar to, or even mirror, certain aspects of the user's health care selection process under element 810 of FIG. 8. For example, a health care provider may register the specific health care services its provides by selecting from one or more drop-down menus that provide a listing of pre-defined health care services. Alternatively or additionally, a health care provider may register the specific health care services it provides through alphabetic text entry.

According to another exemplary embodiment, a health care provider may register the specific health care service(s) it provides by specifying one or more medical diagnostic codes corresponding to such service(s). Alternative or additional forms of registration (e.g., via paper forms, etc.) for health care providers may also be employed in accordance with principles of the present invention described herein.

According to exemplary embodiments, formal approval by administrators of the Cost MD™ application may be required before the health care service offerings and cost information for a given health care provider are made available in the applicable database(s) for purposes of providing health care cost information to users via the Cost MD™ application.

At step 335, the user device 10 executing the Cost MD™ application (or applicable computing system of a website associated with the Cost MD™ application, if for example the application has not been downloaded) determines cost information for each of the one or more health care providers identified at step 333.

According to exemplary embodiments in which the Cost MD™ application has been downloaded to a user device 10, controller 120 of the applicable user device 10 executes the Cost MD™ application at step 335 to determine cost information for each of the one or more health care providers identified at step 333, which is based on the information provided by the health care providers during their registration process with the Cost MD™ application.

According to other exemplary embodiments in which the Cost MD™ application has not been downloaded to a user device 10, a computing system associated with the Cost MD™ website (e.g., cloud 20 of FIG. 1, etc.) executes the Cost MD™ application at step 335 to determine cost information for each of the one or more health care providers identified at step 333, which is based on the information provided by the health care providers during their registration process with the Cost MD™ application.

According to exemplary embodiments, the Cost MD™ application may take into consideration at least one of the following factors, individually or in any combination, at step 335 when determining cost information: current health insurance policy information (e.g., how much of deductible met, co-pay, etc.) for the user, an identity of a referring physician for the health care service, being a cash payer for the health care service, and an indication of no health insurance policy for the user.

According to exemplary embodiments, current health insurance policy information (e.g., how much of deductible currently met, co-pay, etc.) for the user may be taken into consideration when determining cost information at step 335. According to such embodiments, the Cost MD™ application has access to up-to-date information from the user's health insurance policy via the applicable health insurance application, as directed for example, by the user's election to link the particular health insurance policy with the Cost MD™ application at step 313 (e.g., by checking box 630 of user interface 600), or thereafter (e.g., registering via element 850 of FIG. 8).

The Cost MD™ application is also operative to process such information from the user's health insurance policy for purposes of determining a user's financial responsibility for obtaining a given health care service from a given health care provider. Of course, this factor is not taken into consideration in cases where the user is not using health insurance (e.g., the user has no health insurance policy, or otherwise has not registered a health insurance policy at step 310).

According to exemplary embodiments, an identity of a referring physician for the health care service may be taken into consideration when determining cost information at step 335. As indicated above with reference to element 830 of FIG. 8, a user may enter a referring physician or other referring health care provider/entity (if any) for the health care service selected under element 810 and such a factor may be taken into consideration by the Cost MD™ application when determining requested cost information. This factor enables, for example, different health care providers to establish strategic business alliances with other health care providers for purposes of providing preferred cost options (e.g., discounts) for their respective patients upon proper referral. For example, a user may receive a given discount (e.g., 10%, etc.) from a certain health care provider if the user was referred to that health care provider by an affiliated provider.

According to exemplary embodiments, being a “cash payer” for the health care service may be taken into consideration when determining cost information at step 335. As indicated above with reference to element 860 of FIG. 8, a user may indicate if he/she is a “cash payer”, for example that such user intends to pay “cash” (e.g., cash, credit, check, etc.) to the health care provider for the full amount of the health care service at the time of service. For example, a “cash payer” may receive a given discount (e.g., 10%, etc.) from certain health care providers.

According to exemplary embodiments, an indication of no health insurance policy for the user may be taken into consideration when determining cost information at step 335. This indication of no health insurance policy for the user may be represented if, for example, a user has not performed step 310 described above, or has otherwise indicated that no health insurance is being used for the health care service whose cost information is being requested via the Cost MD™ application.

At step 337, the user device 10 executing the Cost MD™ application (or applicable computing system of a website associated with the Cost MD™ application, if for example the application has not been downloaded) assembles the cost information determined at step 335 into a predetermined format for the user.

According to exemplary embodiments, the Cost MD™ application assembles the cost information determined at step 335 into a predetermined display format that may be selected as a matter of design choice. For example, the arrangement of the cost information may be based on highest cost, and/or be assembled in ascending or descending order.

According to exemplary embodiments in which the Cost MD™ application has been downloaded to a user device 10, controller 120 of the applicable user device 10 executes the Cost MD™ application at step 337 to assemble the cost information determined at step 335 into a predetermined display format.

According to other exemplary embodiments in which the Cost MD™ application has not been downloaded to a user device 10, a computing system associated with the Cost MD™ website (e.g., cloud 20 of FIG. 1, etc.) executes the Cost MD™ application at step 337 to thereby assemble the cost information determined at step 335 into a predetermined display format.

Referring now back to FIG. 3, at step 340, the user receives the cost information requested at step 320 via the Cost MD™ application. According to preferred exemplary embodiments, the user receives the cost information at step 340 in real-time, without any substantial delays, in response to the request made at step 320.

According to other exemplary embodiments, the requested cost information may be provided to the user in a manner other than in real-time, such as via an e-mail message sent to a prescribed e-mail address and/or any other type of communication (e.g., regular postal mail, etc.) as specified by the user, for example, under element 870 of FIG. 8.

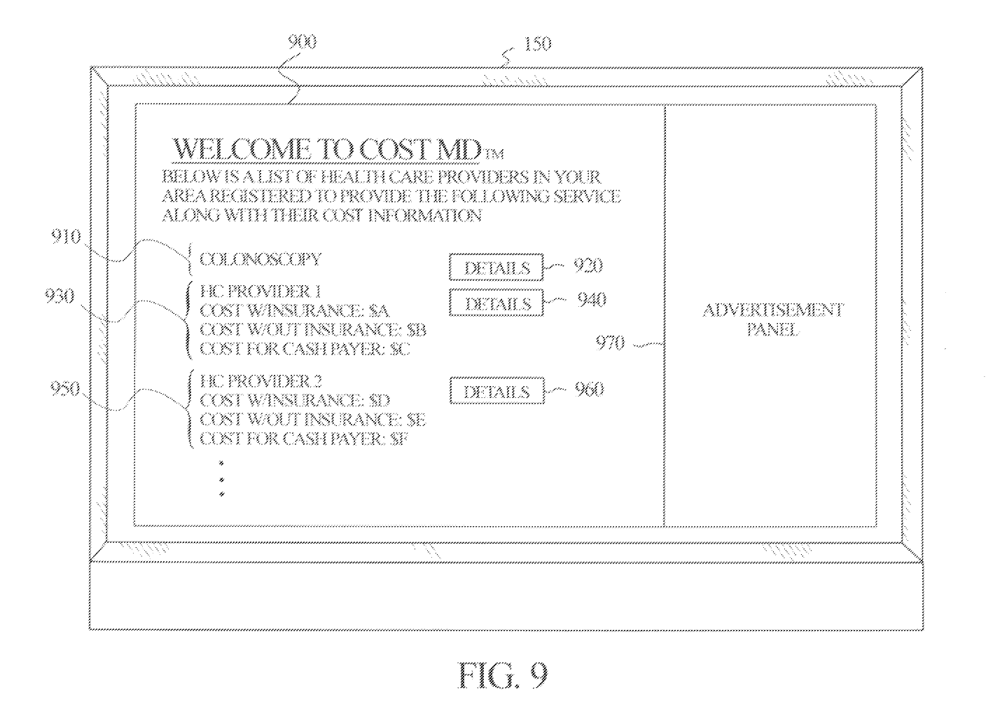

FIG. 9 shows an exemplary user interface 900 that may be used at step 340 of FIG. 3 according to an exemplary embodiment of the present invention. User interface 900 of FIG. 9 is exemplary only and is not intended to limit the present invention in any manner. Although not expressly shown in FIG. 9, user interface 900 may also include some sort of user identification information (e.g., name, address, health insurance policy information, etc.).

Element 910 of FIG. 9 represents a listing of the health care service for which cost information was previously requested at step 320 of FIG. 3, and for example, under element 810 of FIG. 8. As indicated in FIG. 9, element 910 includes an associated “details” icon 920.

According to an exemplary embodiment, a user may select (e.g., click on) icon 920 to access additional details relating to the particular health care service listed under element 910. Such additional details may include any relevant information associated with the particular health care service, such as for example, risk factors, user prep information (e.g., fasting, etc.) and/or other information associated with the particular health care service.

Elements 930 and 950 of FIG. 9 each represents a listing including cost information for an individual health care service provider registered with the Cost MD™ application for performing the health care service specified under element 910. The number of different listings similar to elements 930 and 950 provided in FIG. 9 may vary depending on factors such as screen layout and/or the number of health care providers identified at step 333 of FIG. 5. Of course, the results of a given cost request may involve a plurality of individual screens, such as the one shown in FIG. 9, which may for example be scrolled or otherwise viewed by the user.

As indicated in FIG. 9, such cost information for each health care service provider may include a plurality of different costs depending on the user's circumstances. For example, in FIG. 9 each health care service provider (i.e., health care providers 1 and 2 of elements 930 and 950, respectively) provides separate individual costs based on factors including whether the user is using health insurance (i.e., costs $A and $B for health care provider 1, and costs $D and $E for health care provider 2) and/or is a “cash payer” (i.e., cost $C for health care provider 1 and cost $F for health care provider 2) for the health care service specified under element 910. Of course, costs $A and $D are omitted if the user is not using health insurance (e.g., has not previously identified a health insurance policy during the cost request) for the particular health care service.

Advantageously, the cost information provided under elements 930 and 950 of FIG. 9 may represent “total” cost quotes (albeit, for example, estimates and/or ranges in some cases) for performing the health care service specified under element 910. That is, in situations where the health care service specified under element 910 involves the services of a plurality of different individual health care providers (e.g., as described above herein with reference to a colonoscopy procedure, etc.), the costs listed in FIG. 9 (i.e., costs $A to $F) may represent aggregated or “total” cost quotes that include the costs for services from each one of the different individual health care providers involved in performing the health care service specified under element 910. Depending on market conditions and/or other factors, certain ones of the costs $A to $F may be the same, but all could be different. In this manner, different health care providers are advantageously able to compete with one another on the basis of one or more different cost parameters.

Also in FIG. 9, elements 930 and 950 have associated “details” icons 940 and 960, respectively. According to exemplary embodiments, a user may select (e.g., click on) icons 940 and/or 960 to access additional details relating to the individual health care providers (i.e., health care providers 1 and 2). Such additional details may include any relevant information associated with the particular health care provider, such as for example: an address and/or other contact information (e.g., website, e-mail address, telephone and/or fax numbers, etc.) for the health care provider; a directory and/or listing of information (e.g., names, academic credentials, professional awards, malpractice claims, etc.) relating to any individual health care professional and/or entity that may perform any aspect of the specific health care service specified under element 910; and/or other information. For health care providers that provide radiology or radiation oncology services, such additional details may also include relevant information relating to their equipment, such as the make(s) and model(s) of their imaging scanner(s) or other equipment.

Also indicated in FIG. 9, an advertisement panel 970 may be provided by the Cost MD™ application. According to exemplary embodiments, advertisement panel 970 provides a visual display of one or more individual advertisements and/or other types of information (e.g., sponsorship information, news feed information relating to the Cost MD™ application, current events, etc.), and may be similar to advertisement panel 890 of FIG. 8 described previously herein.

According to exemplary embodiments, at least one of the individual advertisements displayed in advertisement panel 970 corresponds to one of the health care providers (i.e., health care providers 1 and 2 in FIG. 9) whose cost information is being provided (i.e., displayed under elements 930 and 950 in FIG. 9). In this manner, the present invention may employ principles of coordinated display (e.g., in real-time) between the advertisements displayed by advertisement panel 970 and the health care service specified under element 910.

Also according to exemplary embodiments, such advertisements may include predetermined (e.g., “discount”) codes listed that may be redeemed by the user by employing that particular health care provider to provide the health care service specified under element 910. In this manner, advertisement panel 970 of FIG. 9 may offer yet another cost option for users (i.e., in addition to cost options $A-C and $D-F for health care providers 1 and 2, respectively) from health care providers for a specified health care service, and also enable health care providers to compete against one another on the basis of cost.

As described above herein, the present invention provides methods and systems which, among other things, advantageously provide health care users with cost information for health care services and thereby enable such health care users to make more informed and cost-effective decisions regarding their personal health care and/or health care providers to compete against one another on the basis of cost.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-20. (canceled)

21. A method, comprising:
receiving, via a website, a user input requesting cost information for a health care service;
providing, via said website and in response to said user input, a display including a listing of one or more health care providers and cost information for each of said one or more health care providers for providing said health care service; and
wherein said display further includes an advertisement that is separate and apart from said listing and is specifically for one of said one or more health care providers whose said cost information is currently displayed.

22. The method of claim 21, wherein said user input indicates a geographical area.

23. The method of claim 21, wherein said website is associated with a health insurance company.

24. The method of claim 21, wherein:
said user input includes health insurance information for said user; and
said health insurance information includes one of:
an indication of said user having health insurance coverage; and
an indication of said user not having health insurance coverage.

25. The method of claim 21, wherein said cost information for at least one of said one or more health care providers in said listing includes a plurality of different costs comprising:
a first cost associated with said user having health insurance coverage; and
a second cost associated with said user not having health insurance coverage.

26. The method of claim 21, wherein said user input specifies said health care service by one or more medical codes.

27. The method of claim 21, wherein said cost information includes consideration of at least one of:
a deductible of a health insurance policy for said user; and
a co-pay of said health insurance policy for said user.

28. The method of claim 21, wherein said cost information includes a cost reduction based on an identity of a referring physician for said health care service.

29. The method of claim 21, wherein said cost information includes consideration of said user being a cash payer at a time of service for said health care service.

30. The method of claim 21, wherein said health care service includes services from a plurality of different health care providers.

31. The method of claim 21, wherein said cost information comprises a cost estimate.

32. A method, comprising:
receiving, via a website associated with a health insurance company, a first user input including identification information for a user;
providing, via said website and in response to said first user input, a first display at a user device including an option for requesting cost information for a specified health care service;
receiving, via said website, a second user input requesting cost information for said specified health care service;
providing, via said website and in response to said second user input, a second display at said user device including cost information for providing said specified health care service; and
wherein said second display further includes an advertisement that is separate and apart from said cost information and is specifically for at least one health care provider associated with said health insurance company.

33. The method of claim 32, wherein said second user input indicates a geographical area.

34. The method of claim 32, wherein said cost information comprises a cost estimate.

35. The method of claim 32, wherein at least one of:
said advertisement is specifically for a health care provider whose said cost information is currently displayed; and
said advertisement includes a redeemable discount code.

36. The method claim 32, wherein said cost information includes consideration of at least one of:
a deductible of a health insurance policy for said user; and
a co-pay of said health insurance policy for said user.

37. The method of claim 32, wherein said health care service is specified by one or more medical codes.

38. The method of claim 32, wherein said cost information includes a cost reduction based on an identity of a referring physician for said specified health care service.

39. A system, comprising:
computer hardware operative to execute computer software, which when executed, causes or enables performance of steps comprising:
receiving, via a website associated with a health insurance company, a first user input including identification information for a user;
providing, via said website and in response to said first user input, a first display at a user device including an option for requesting cost information for a specified health care service;
receiving, via said website, a second user input requesting cost information for said specified health care service;
providing, via said website and in response to said second user input, a second display at said user device including cost information for providing said specified health care service; and
wherein said second display further includes an advertisement that is separate and apart from said cost information and is specifically for at least one health care provider associated with said health insurance company.

40. The system of claim 39, wherein said advertisement is specifically for a health care provider whose said cost information is currently displayed in said second display.
